(19) United States
(12) Patent Application Publication
(10) Pub. No.: US 2012/0118691 A1
(43) Pub. Date: May 17, 2012

(54) Method and an apparatus for safe packing

(76) Inventor: Jean-Marcel Ribaut, Texcoco (MX)

(21) Appl. No.: 13/199,156

(22) Filed: Aug. 22, 2011

Related U.S. Application Data
(63) Continuation-in-part of application No. 11/799,703, filed on May 2, 2007, now abandoned.
(60) Provisional application No. 60/796,844, filed on May 2, 2006.

(51) Int. Cl. A45C 13/02; B65B 55/20; B32B 27/00; A45C 5/03

(52) U.S. Cl. 190/103; 190/109; 53/436; 428/220

(57) ABSTRACT

The present invention relates to transportation containers and luggage; and, more particularly, it relates to a method and apparatus to prevent items from shifting or breaking in the container or luggage while moving or during travel.

This application claims priority of the U.S. Provisional Application No. 60/796,844 filed on May 2, 2006. The entire contents of the prior application U.S. provisional 60/796,844 is incorporated herein by reference.

This application repeats substantial portions of a prior application Ser. No. 11/799,703, filed May 2, 2007 and adds and claims additional disclosure not presented in the prior application. Since this application names an inventor named in the prior application, it may constitute a continuation-in-part of the prior application, claiming benefit of the filing date of the prior application (35 USC 120; 37 CFR 1.78)

### FIELD OF THE INVENTION

The present invention relates to transportation containers and luggage; and, more particularly, it relates to a method and apparatus to prevent items from shifting or breaking in the container or luggage while moving or during travel.

### BACKGROUND OF THE INVENTION

People traveling a lot are very familiar with the fact that even if they have suitcases of various shapes and sizes. There is often empty space left in the suitcase. Even if the suitcases usually have means to stabilize the packed items, often the items still move in the suitcase during travel. This again leads to a situation that the garments for example get wrinkled during travel and mass are not ready to be used when unpacking. Moreover, fragile items may get broken during the travel. Similar problems may be encountered when sending items in a box, containing or similar structure by any transportation means. It is well known practice to wrap fragile items into multiple sheets of paper for bubble plastic to prevent the items from shifting and breaking in the box while moving the box.

Attempts have been made to improve the attachment of the items in the suitcase. In addition to various kinds of clips and strings in suitcase. There are also applications involving inflatable inserts that are used to protect the packed items during travel. For example, U.S. Pat. No. 6,065,870 discloses an inflatable bladder. That is to be inserted into the suitcase to protect the items.

There not many improvements available for protecting items in moving boxes. U.S. Pat. No. 4,597,244 provides a method for forming inflated wrapping bags, but this method is designed for manufacture or other industrial entities only as requires heat sealing equipment.

The drawback in the approaches currently known is that the inflatable bladder is to be inflated before the suitcase were box is closed. This means that the bladder may after all. Not fill the empty spaces in the suitcase of box, but nearly give a cushion effect, thereby protecting the items from breaking during movements are not protecting them from moving.

Accordingly, there is a need for a method and apparatus they would protect the packed items from moving and from breaking. The current disclosure provides a method and apparatus to protect the items in the suitcase or a box. Also to fix them in the original position by preventing them from moving during travel. The current disclosure also provides a method and apparatus to fill the empty places in the suitcase, box or other structure fully.

### SUMMARY OF THE INVENTION

The instant invention provides a solution to the problems encountered by the currently known approaches. The purpose of the current invention is to provide an apparatus to protect the items in the suitcase or a box, but also to fix them in the original position by preventing them from moving during travel.

According to one embodiment of the current invention the compartment of a divider of a regular suitcase is made of plastic instead of plain cardboard or other regularly use material. According to this embodiment, the compartment divider is an inflatable bladder like divider, and it fixes the items in the suitcase in fixed positions and fills the empty space in between the items according to another embodiment. The compartment divider comprises two cardboard, or one cardboard and one wall of this suitcase, and then inflatable plastic bladder attached in between of the rigid cardboard with a suitcase wall and the cardboard. According to this embodiment, the divider is a rigid element and the inflatable element is between the carports.

The suitcase is packed as usual, and the compartment of either regardless of whether is comprises only in the bladder or additionally needed carboards is laid down on top of the packed items as usual. The other half of the suitcase is, as usual, and the suitcase closed. The compartment divider is inflated after suitcase closed by a valve that is outside of the suitcase. The compartment divider may be inflated by using a hand-held pump or any manner or automatic system (compressed air cartridge).

According to another embodiment, the compartment divider or an inner wall of the suitcase comprises expendable material, they can react for example to change in temperature or pressure. When this suitcase is for example in the luggage compartment of an airplane, where both temperature and air pressure decrease the expendable material would inflate and thereby protect the items inside the suitcase. According to yet another embodiment, the inflatable bladder is used in a box to prevent items shifting the box while move.

Yet another embodiment is a box or suitcase, where the inner side of the box with the suitcase is covered with an inflatable bladder, which when inflated can protect the items from each side of the box or suitcase.

Still another embodiment of this invention provides inflatable bags where fragile items may be packed individually in a suitcase or in a box or any other container to prevent them from getting broken. The bag may be made of one layer in the air to be inflated into the bag or the bag may be made out of two layers and the air is inflated in between the two layers.

As is well known to those skilled in the art, an inflatable object such as a bladder assumes a new shape and a new volume upon inflation, depending on (1) internal pressure reached; and, (2) the material from which the inflatable object is made. Thus, when the inflatable material is hard, unyielding or inflexible, conformation of the bladder environment is highly limited. The present inventors have recognized that one of the chief failings of the prior art is a failure to recognize the importance of the material from which the inflatable object is prepared. The present invention recognizes for the first time that It is highly desirable for the inflatable diaphragm or balloon to expand quickly and readily upon increases in pressure conforming to the space within the suitcase and to conform around the objects for which it is intended to protect. It is furthermore desirable that this material be easily inflated. The present inventor has found that elastomeric polymers are highly suited to this particular application. It is further recognized and is therefore yet another embodiment of the present invention, that the elastomer material be in the physical form of a film and that the film be about 3-5 mil in thickness. Furthermore, the material should be soft and readily stretchable so that it expands and reacts instantly to changes in internal pressure. Thus, when the suitcase is closed, the film conforms to the size and shape of the items to be protected while occupying all of the free space within the closed suitcase. Free space defined as the difference between the total volume of the closed suitcase when empty and the volume when packed to the desired level.

It is further recognized that the diaphragm material or bladder material in this present invention will be extended frequently due to frequent use and that it will be stretched for extended periods of time during long hours of travel. It is therefore an important property of the bladder material that it have a relatively low permanent set and a relatively low level of creep. This means that permanent deformation due to repeated in long exposures to air pressure will not take the diaphragm out of shape, cause it to become larger than intended and cause it to be inefficient in its ability to expand and hold objects in place.

Therefore, it is in a further embodiment of the present invention, that the material of the present invention used to construct the divider/bladder be elastomeric, readily stretched upon inflation, easily conforming to the shape and size of the items to be protected from movement and shifting during travel. To meet these objectives the present inventor has defined these desirable qualities in terms of tensile properties which are generally considered by those skilled in the art to correlate with the objectives of the present invention as described herein.

Thus in a preferred embodiment of the present invention, the divider/diaphragm/bladder is comprised of a soft, flexible elastomeric film 3-5 mil in thickness and exhibiting the following tensile properties as measured in accordance with ASTM D412: tensile stress @100% elongation of 450-1000 psi; elongation @ break of 500-700%; tensile set @200% elongation of 15-25%. Rubbers deform under load and rarely return completely to their original dimensions. When the load is removed. The difference between the original and the final dimensions is known as permanent set and can be measured and tension, compression or sheer. In the ASTM D412 testing procedure referenced herein, permanent set is referred to as tension set.

For purposes of the present invention the term elastomer is defined as a polymer with a property of visco-elasticity, generally having low modulus and high elongation. The term is derived from elastic polymer, and is often used interchangeably with the term rubber. Elastomers are amorphous polymers existing above the glass transition temperature, so that considerable segmental motion is possible. At ambient temperatures elastomers are relatively soft and deformable. Their primary uses are for seals, adhesives and molded flexible parts.

Examples of elastomer polymers suitable for the present invention include but are not limited to natural isoprene, synthetic isoprene, polybutadiene, chloroprene rubber, butyl rubber, styrene butadiene rubber, nitrile rubber, ethylene-propylene rubber, epichlorohydrin rubber, poly acrylic rubber, silicone rubber, fluorosilicone rubber, perfluoro elastomers, polyether block amides, chlorosufonated polyethylene, ethylene-vinyl acetate, polysulfide, and polyurethane.

In a most preferred embodiment of the present invention, the bladder is comprised of a polyurethane film; most preferably, the polyurethane film has the following properties: 4-5 mil thick, tensile stress @100% elongation about 900 psi; and, elongation @ break of 550%. An example of a polyurethane film having said preferred properties is Argothane 18103 (Argotec, Inc. 53. Silvio O. Conte Dr., Greenfield, Mass. 01301)

### BRIEF DESCRIPTION OF THE DRAWINGS

FIG. 1 illustrates an open suitcase with a compartment divider.

FIG. 2 illustrates a close case, with an inflated compartment divided.

FIG. 3 illustrates a close suitcase having the valve in the top wall.

FIG. 4 illustrates a close suitcase with the inflatable compartment divider is inflated with a pump through a valve positioned on the top wall.

FIG. 5 illustrates a close suitcase with the inflatable compartment divider is attached to the side will of the suitcase and the valve locates on the side wall, thereby allowing inflation of the divider through the seam along which the divider is attached to the wall.

FIG. 6 is a view of the bottom of the suitcase with the pump is fixed into a compartment between the wheels of the suitcase.

FIG. 7 illustrates closed suitcases where the inflatable compartment divider comprises two cardboards and inflatable bladder like element inbetween the cardboard. The divider is attached to the side wall of the suitcase and the valve locates on the side wall, thereby allowing inflation of the divider through the seam along which the divider is attached to the wall. The divider comprises two cardboard that may be attached to the side wall so that they may form an angle when the bladder is inflated, or alternatively they may be parallel whereby they also move parallel when the bladder is inflated.

FIG. 8 illustrates a closed suitcase, where the inflatable bladder like element is between two cardboard and the cardboard pressed together with a clip and the bladder is empty.

FIG. 9 illustrates a box, where the inflatable divider is attached to the lower part of the box. In the figure the cardboard form an angle when the bladder is inflated but as well the cardboard can be attached parallel.

FIG. 10 illustrates a box, where the inflatable divider is attached to the cover part of the box.

FIG. 11 illustrates a bag inflated with air via of valve after packing a fragile item in the bag and closing the bag with his zipper

### DETAILED DESCRIPTION OF A PREFERRED EMBODIMENT

With reference now to the drawings, an improved suitcase embodying the present invention is described.

The improved suitcase according to the present invention includes a suitcase (1) or a box (16) with a compartment divider (2). The compartment divider Is a fixed portion of the suitcase or box being attached to a bottom (3), top (4) or side (5) wall of the suitcase or to any wall of the box. The compartment divider may be made of two cardboard (10) and include an inflatable bladder like element (14) in between of the cardboards. The compartment can also be made by one cardboard and the largest wall of the suitcase has fixed element with an inflatable bladder like element (14) in between the suitcase wall and cardboard. Alternatively, divider is a bladder, and it made out of plastic or any other material that can form such a bladder. The compartment divider is inflatable and deflatable through a valve (6) that locates outside the suitcase or the box, or inserted in any wall or element of the suitcase or box, thereby enabling inflating and deflating the compartment divider when a suitcase or the box is closed. This allows the user to fill the compartment divider to the exact amount that is needed in order to fill in all the empty places in a suitcase or the box.

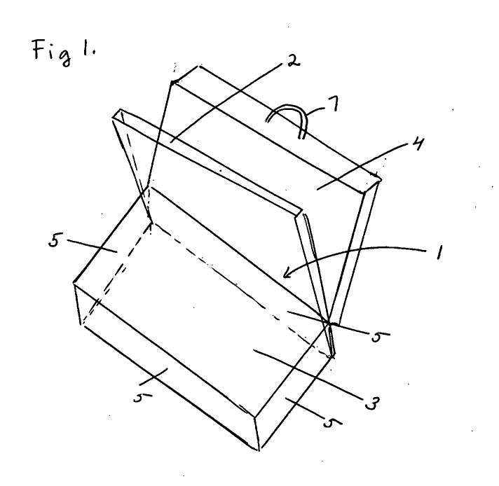

FIG. 1 illustrates a suitcase (1) with an inflatable bladder like compartment divider (2). According to this embodiment, the divider (2) is attached to the seam between the bottom wall (3) and the side wall (5) of the suitcase.

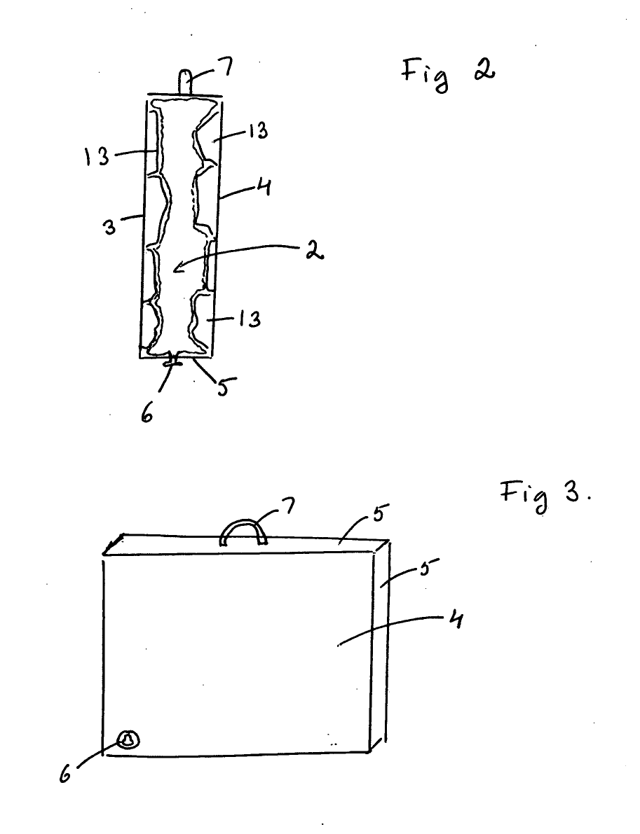

FIG. 2 illustrates a close suitcase with a bladder like compartment divider (2) that is filled exactly so that it fills the empty spaces between the items (13) in the suitcase. In the embodiment illustrated in FIG. 2, the divider does not include rigid cardboard elements, but comprises only have the bladder. In this embodiment of valve (6) locates on one side wall of the suitcase.

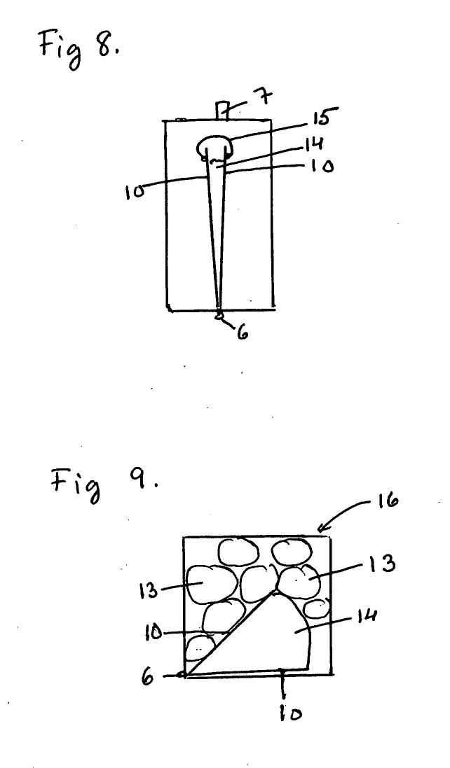

FIG. 7 illustrates an embodiment where the divider comprises two cardboard (10) and the inflatable bladder (14) is in between are the cardboard. When the bladder is inflated, as shown in FIG. 7, the items (13) are fixed at their places. The cardboard may be attached to the wall so as to form an angle when the bladder is inflated or they may be attached parallel so that they move parallel with the bladder is inflated.

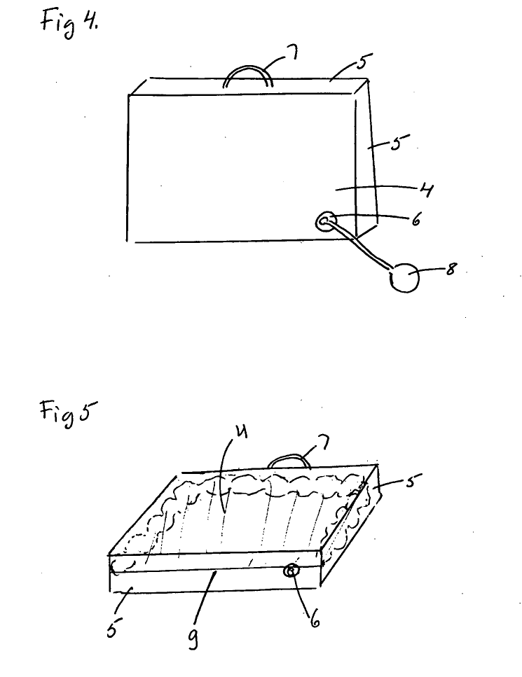

FIG. 4 illustrates a suitcase having a valve (6) on the top wall of the suitcase. The bladder like compartment divider may be inflated with a manual pump (8) for example. FIG. 4 illustrates a suitcase having the valve (6) on the top wall (4) of the suitcase and being filled with the pump (8).

According to a preferred embodiment the pump is integrated in the structure of the suitcase: at the bottom between the wheels or in the handle. FIG. 6 illustrates an embodiment where the pump (8) is fixed under the suitcase, in a compartment (11) between the wheels (12). The compartment (11) may be an open or a close one.

The person inflating the bladder may feel the increase resistance when no more air goes into the divider. At this point, the bladder like divider fills all the empty spaces in the suitcase and the items (13) packed cannot move from their original places. FIGS. 2, 7, 9 and 10 illustrates how the items (13) are fixed on their places when the bladder is inflated.

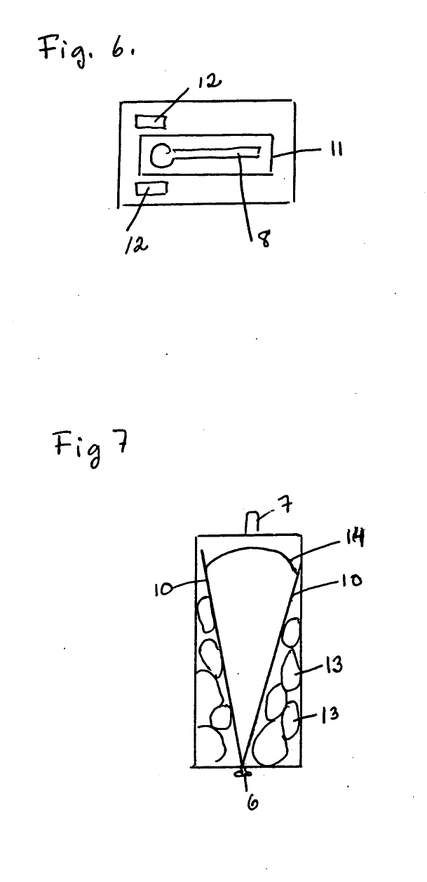

The valve may locate on any of the outside walls of the suitcase of the box. According to a preferred embodiment of valve locates outside of the wall into which the compartment divider is attached, thereby leading to the divider bladder to the side of the divider that is attached to the respective wall of the suitcase. FIG. 5 illustrates an embodiment where the bladder like compartment divider is attached to the side wall (5) of the suitcase and the valve locates outside of the sidewalk, thereby allowing the air to enter the bladder like divider through the seam (9), along which the divider is attached to the sidewall (5).

Usually the compartment divider is attached to one of the side walls (5) of the suitcase and in such case the valve is preferably outside or inserted in the sidewalk.

According to one embodiment, the valve system is located in the handle (7) of the suitcase. According to another embodiment of valve system may be automated and a bladder like divider may be inflated by regulating an adjuster in the handle of the suitcase.

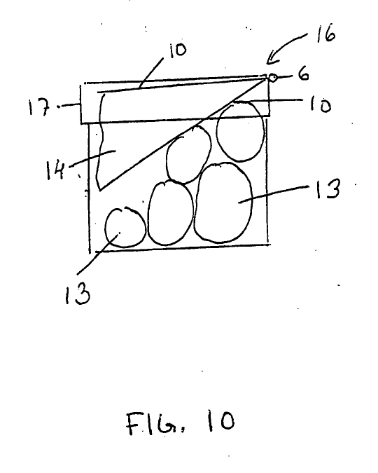

According to the embodiment where the bladder like element (14) locates in between the two cardboard (10), the bladder may be emptied by opening the valve (6) and attaching the two cardboard together with a rubber band, a clip or other suitable element to press the carboards together. FIG. 8 illustrates an embodiment where the two car boards (10) are attached together with the clip (15) and a bladder like element (14 is deflated.

According to the embodiment where the divider does not contain the cardboard, that the latter may be emptied by opening the valve and manually pressing the air out of the bladder.

According to still another embodiment of the invention is a box, with any type of container, used for example for mailing items, where the box contains a divider comprising a bladder like element. The divider may be attached to any of the side walls of the box or it may be attached to the cover portion of the box. FIG. 9 illustrates a box (16), where a bladder like element (14) is inflated in between up to cardboard (10). The divider comprised of it to cardboard and the bladder-like element is attached in this figure to the lower part of the box.

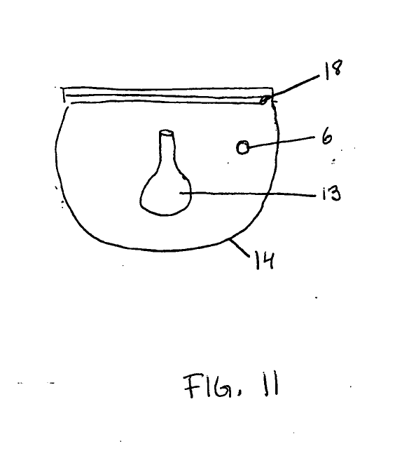

FIG. 10 illustrates a box (16), where the divider comprising two cardboard's (10) and a bladder like element (14) is attached to the cover part (17) of the box. The cardboard can be attached in a way that they form an angle when the bladder is inflated, but they can be attached also in a way that they moved parallel when the bladder is inflated. It is also possible that the divider comprises only the bladder like element, with only one or without the cardboards, similarly, as described in connection with a suitcase embodiment.

FIG. 11 illustrates yet another embodiment, where the item is packed in the bladder-like element itself. The bladder like element is a bag, which is closed for example, with a zipper (18). The bag is inflated with air via a valve (6) on the side of the bag. The bag can be deflated simply by opening the zipper. The inflatable bag according to this embodiment can be used over and over again. The bag may be used to pack fragile items without a need to wrap the items in paper or bubble plastic. The bag may be made of plastic and be transparent, or it may be made of any other suitable material.

A person skilled in the art will understand that invention according to this disclosure may be conducted with various changes without dividing from the idea of this invention.

1. A suitcase having a compartment divider, said divider being inflatable and deflatable via a valve locating on an outer wall of the suitcase while the suitcase is closed; wherein said divider is comprised of a soft, flexible elastomeric film 3-5 mil in thickness and exhibiting the following tensile properties as measured in accordance with ASTM D412: tensile stress @100% elongation of 450-1000 psi; elongation @ break of 500-700%; tensile set @200% elongation of 15-25%.

2. The suitcase of claim 1, wherein the compartment divider consists of two cardboards and an inflatable bladder between the cardboard.

3. The suitcase of claim 1, wherein the compartment divider consists of one cardboard and an inflatable bladder between the divider and one wall of the suitcase.

4. The suitcase of claim 1, wherein the compartment divider is an inflatable bladder.

5. (canceled)

6. The suitcase of claim 1, wherein the compartment divider is inflatable with a pressure pump.

7. The suitcase of claim 6, wherein the pressure pump is attached on the suitcase.

8. (canceled)

9. A box comprising a divider, said divider being inflatable and deflatable via a valve locating on an outer wall on the box while the box is closed.

10. The box of claim 9, wherein the compartment divider consists of two cardboard and inflatable bladder between the cardboard.

11. The box of claim 10, wherein one of the cardboard is one of the walls of the box.

12. The box of claim 10, wherein the compartment divider is an inflatable bladder.

13. The box of claim 12, wherein the inflatable bladder is made of plastic.

14. The box of claim 9, wherein the compartment divider is inflatable with a pressure pump.

15. A method to protect items while transporting them, said method comprising the steps of:
a) inserting the items in a container;
b) setting a compartment divider of the container of the items, said compartment divider comprising an inflatable bladder;
c) optionally inserting further items on top of the compartment divider;
d) closing the container; and.
Pumping a desired amount of air into the inflatable bladder via a valve locating on an outer wall of the container.
wherein said inflatable bladder is comprised of a soft, flexible elastomeric film 3-5 mil in thickness and exhibiting the following tensile properties as measured in accordance with ASTM D412: tensile stress @100% elongation of 450-1000 psi; elongation @ break of 500-700%; tensile set @200% elongation of 15-25%.

16. The method of claim 15, wherein the container is a suitcase.

17. The method of claim 15 wherein the containers of box.

18. (canceled)

19. The method of claim 12, where the air-tight closing system is a zipper.

20. (canceled)

21. The film according to claim 1 wherein the film thickness is 4-5 mils, the film tensile stress @100% elongation is about 900 psi; and, elongation @ break is about 550%.

22. The film according to claim 1 said film comprised of one or more of the following elastomeric polymers: natural isoprene, synthetic isoprene, polybutadiene, chloroprene rubber, butyl rubber, styrene butadiene rubber, nitrile rubber, ethylene-propylene rubber, epichlorohydrin rubber, poly acrylic rubber, silicone rubber, fluorosilicone rubber, perfluoro elastomers, polyether block amides, chlorosufonated polyethylene, ethylene-vinyl acetate, polysulfide, and polyurethane.

23. The film according to claim 21 wherein said film is comprised of a polyurethane elastomer.

24. A closed suitcase having an inflated compartment divider, wherein said divider is comprised of a soft, flexible elastomeric film 3-5 mil in thickness and exhibiting the following tensile properties as measured in accordance with ASTM D412: tensile stress (100% elongation of 450-1000 psi; elongation (break of 500-700%; tensile set @200% elongation of 15-25%; and, wherein said inflated divider occupies substantially all of the free space within said closed suitcase.
